(19) United States
(12) Patent Application Publication
(10) Pub. No.: US 2013/0091004 A1
(43) Pub. Date: Apr. 11, 2013

(54) System and Method for Generating Electronic Combined Source Promotions

(71) Applicant: Marvin Gottlieb, Los Angeles, CA (US)

(72) Inventor: Marvin Gottlieb, Los Angeles, CA (US)

(21) Appl. No.: 13/648,193

(22) Filed: Oct. 9, 2012

Related U.S. Application Data
(60) Provisional application No. 61/545,057, filed on Oct. 7, 2011.

(51) Int. Cl. G06Q 30/02

(52) U.S. Cl. 705/14.35; 705/14.72; 705/14.45

(57) ABSTRACT

In exemplary embodiments of a system and method for generating electronic combined source promotions, a server is typically provided in communication between at least a user and a merchant. A graphical user interface allows a user to submit a video content item which includes a personal review or recommendation by the user relevant to a product, service or business of the merchant. A graphical merchant interface allows the merchant to review the video and elect to incorporate it in a promotion, which combines the video with offer parameters entered by the merchant for the sale of a redeemable voucher. The promotion is then electronically published in a manner allowing a consumer to view the promotion and purchase the associated voucher. The user who uploaded the content item may be rewarded with cash, discounts or status points. A portion of the purchase price of the voucher is disbursed to the merchant.

### RELATED APPLICATIONS

This application claims the benefit of U.S. Provisional Application No. 61/545,057, filed on Oct. 7, 2011, the contents of which are incorporated by this reference in its entirety for all purposes as if fully set forth herein.

### TECHNICAL FIELD

The present invention relates generally to the creation and propagation of electronic merchant advertising.

### BACKGROUND

Creating and propagating effective advertising campaigns can be time-consuming and expensive for merchants. What is needed are systems and methods which facilitate the rapid creation of more effective promotional content at lower cost to the merchant, particularly where such content leverages the reputation of people close to or trusted by potential customers.

### SUMMARY

Certain deficiencies of the prior art may be overcome by the provision of a system and method involving, for example, a web based platform that allows consumers to upload and share videos of products and services they love and sequentially allows respective merchants to launch these videos by attaching instant automated web discount offers or otherwise manage or utilize such videos in furtherance of their business goals. Visitors and members can view video experiences and purchase vouchers for these discount offers.

Embodiments of the system and method may include and operate by way of a website and mobile application that allows people to share their love and upload videos about their favorite products and services, creating a unique symbiotic connection with businesses. In return for spreading the love, business owners may reward video creators by attaching great discount offers to share with friends and the entire web universe. The invention goes beyond the “like” button, text review, and “check in,” allowing passionate customers to become the “face” of their favorite brands, companies, shops, and products. This greatly benefits the shopper, who now sees a user recommended video experience from someone they trust or admire, with a deal attached, prior to purchase. Embodiments of the invention therefore allow businesses to receive and manage these consumer generated videos to market their company across the web, potentially utilizing these videos forever. In preferred embodiments, businesses can use these videos to attract new and existing customers, and can launch deals instantly wherever and whenever they want, rotating videos and deals using the application platform, essentially running their own media campaign. Loving customers become their business marketing engine.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 illustrates a method in accordance with an embodiment of the present invention;

FIG. 2 is a block diagram illustrating a system in accordance with an embodiment of the present invention;

FIG. 3 illustrates a Discover page of an embodiment of a graphical user interface;

FIG. 4 illustrates a Filter page of an embodiment of a graphical user interface;

FIG. 5 illustrates a Today page of an embodiment of a graphical user interface;

FIG. 6 illustrates a first portion of a Deal page of an embodiment of a graphical user interface;

FIG. 7 illustrates a second portion of the Deal page of FIG. 6;

FIG. 8 illustrates a third portion of the Deal page of FIG. 6;

FIG. 9 illustrates a fourth portion of the Deal page of FIG. 6;

FIG. 10 illustrates a General Rules page, which lists example rules which may be applicable to all vouchers purchased by way of certain embodiments of the graphical user interface;

FIG. 11 illustrates a first portion of a Discover Merchant page of an embodiment of a graphical user interface;

FIG. 12 illustrates a second portion of the Discover Merchant page of FIG. 11;

FIG. 13 illustrates a third portion of the Discover Merchant page of FIG. 11;

FIG. 14 illustrates a Following page of an embodiment of a graphical user interface;

FIG. 15 illustrates a first portion of a User Profile page of an embodiment of a graphical user interface;

FIG. 16 illustrates a second portion of the Discover Merchant page of FIG. 15;

FIG. 17 illustrates a first portion of a User Profile page similar to that of FIG. 15, but in which the respective user has attained celeb status either by instant designation through the site operator, or by having accumulated sufficient incentive points, thereby receiving a Celeb Badge on their User Profile page;

FIG. 18 illustrates a Voucher Purchase page of an embodiment of a graphical user interface; the Voucher Purchase page may also be considered to form part of what may be referred to as a graphical purchase interface;

FIG. 19 illustrates a Send as a Gift page of an embodiment of a graphical user interface, whereby the user who has purchased the Voucher can send the Voucher to another user as a gift, the Send as a Gift page preferably being accessible by way of the Voucher Purchase page;

FIG. 20 illustrates a User Sign Up page of an embodiment of a graphical user interface;

FIG. 21 FIG. 20 illustrates a User Login page of an embodiment of a graphical user interface;

FIG. 22 illustrates a Create New Video page of an embodiment of a graphical user interface, whereby the user can select or create a video content item using their computing device to submit for approval and use by the respective merchant;

FIG. 23 illustrates a User How it Works page of an embodiment of a graphical user interface, which describes to the user how they can earn rewards and status points through their submission of video content for use in a merchant promotion;

FIG. 24 illustrates a Submit Video page of an embodiment of a graphical user interface, the respective merchant being searchable from the server element database or by a web search functionality when the merchant is not yet stored in the server element;

FIG. 25 illustrates a first portion of a Dashboard page of an embodiment of a graphical user interface;

FIG. 26 illustrates a second portion of the Dashboard page of FIG. 25;

FIG. 27 illustrates a third portion of the Dashboard page of FIG. 25;

FIG. 28 illustrates a fourth portion of the Dashboard page of FIG. 25;

FIG. 29 illustrates a My Videos page of an embodiment of a graphical user interface;

FIG. 30 illustrates a My Purchases page of an embodiment of a graphical user interface;

FIG. 31 illustrates a first portion of a Purchase Details page accessed from the My Purchases page of FIG. 30, a Show Voucher button being presented for bringing up the redeemable Voucher;

FIG. 32 illustrates a second portion of the Purchase Details page of FIG. 31;

FIG. 33 illustrates a Voucher page presenting the purchased voucher in directly redeemable form;

FIG. 34 illustrates an Invite a Friend page of an embodiment of a graphical user interface;

FIG. 35 illustrates a My Rewards page of an embodiment of a graphical user interface;

FIG. 36 illustrates a Merchant Login page of an embodiment of a graphical merchant interface;

FIG. 37 illustrates a first portion of a Merchant Sign Up page of an embodiment of a graphical merchant interface;

FIG. 38 illustrates a second portion of the Merchant Sign Up page of FIG. 37;

FIG. 39 illustrates a first portion of a Merchant How it Works page of an embodiment of a graphical merchant interface;

FIG. 40 illustrates a second portion of the Merchant How it Works page of FIG. 39;

FIG. 41 illustrates a Merchant Queue page of an embodiment of a graphical merchant interface;

FIG. 42 illustrates a first portion of a Create Deal page of an embodiment of a graphical merchant interface, the Create Deal page enabling a merchant to trigger the generation of a promotion incorporating at least a portion of the respective video content item and an offer of a voucher;

FIG. 43 illustrates a second portion of the Create Deal page of FIG. 42;

FIG. 44 illustrates a Merchant Deal List page of an embodiment of a graphical merchant interface, showing the merchant's active deals;

FIG. 45 illustrates a Merchant Deal List page similar to that of FIG. 44, but showing the merchant's expired deals;

FIG. 46 illustrates a Merchant Deal Detail page of an embodiment of a graphical merchant interface;

FIG. 47 illustrates a Merchant Redeem page of an embodiment of a graphical merchant interface, wherein a voucher number has yet to be entered;

FIG. 48 illustrates the Merchant Redeem page of FIG. 47, but wherein a voucher number is being entered into the search field;

FIG. 49 illustrates the merchant view of the voucher about to be marked as redeemed;

FIG. 50 illustrates a Merchant My Account page of an embodiment of a graphical merchant interface;

FIG. 51 illustrates a Merchant Account Settings page of an embodiment of a graphical merchant interface; and

FIG. 52 illustrates a Merchant Edit Profile page of an embodiment of a graphical merchant interface.

### DETAILED DESCRIPTION OF THE PREFERRED EMBODIMENTS

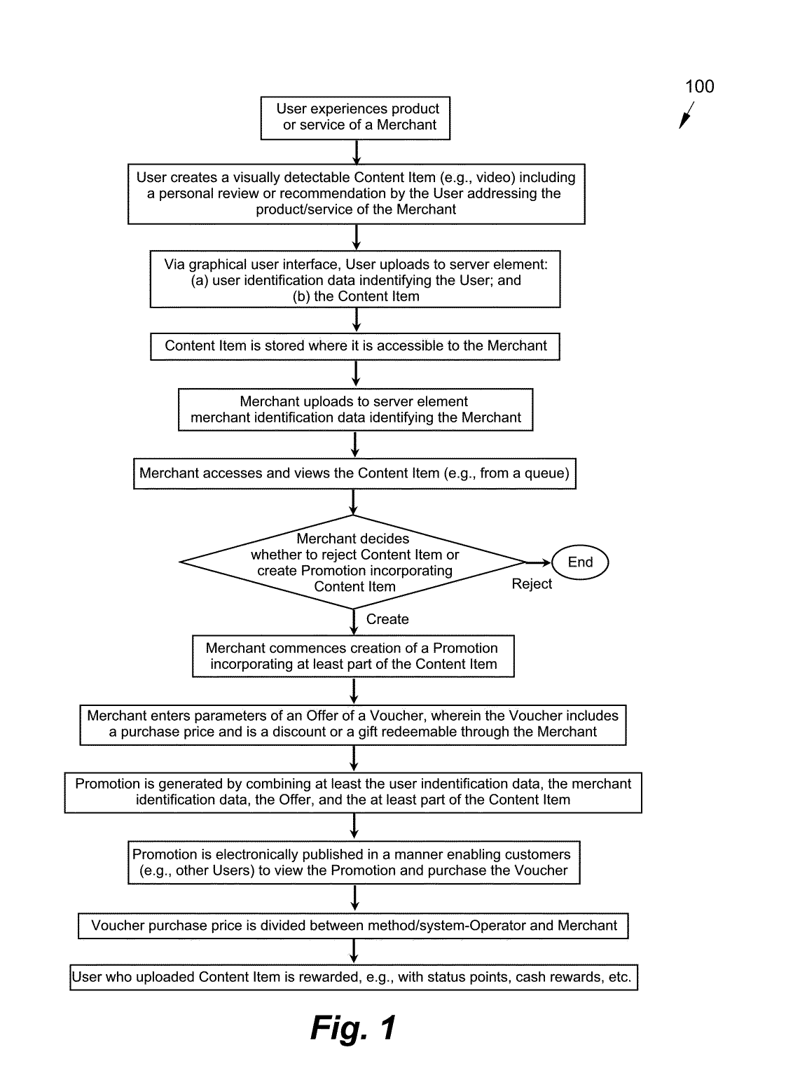

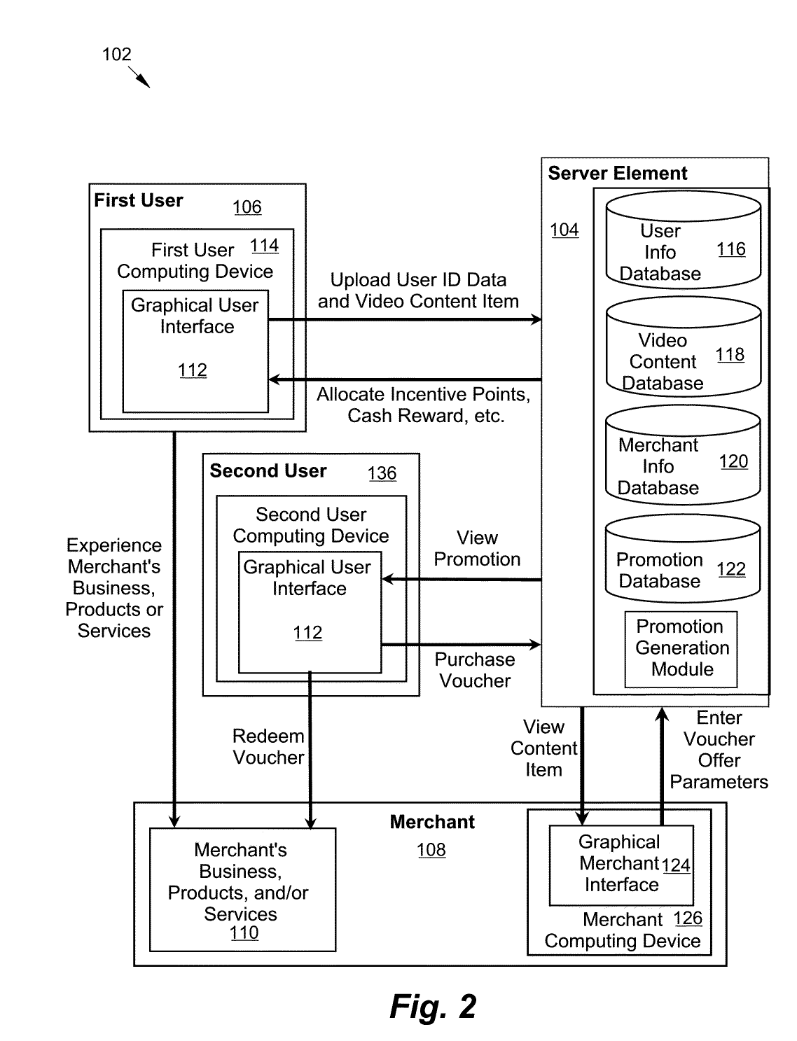

Referring now to the drawings, like reference numerals designate identical or corresponding features throughout the several views. Referring in particular to FIGS. 1 and 2, exemplary embodiments of a method 100 and system 102 of generating electronically published promotions are provided. A server element 104 may be provided in communication between at least a user 106 and a merchant 108. The server element 104 may be comprised of one or more servers, which may or may not be collocated, either in the same rack, room or operating location. The servers may generally be connectedly associated with storage elements, such as, for example, one or more of a user information database 116 , video content database 118, merchant information database 120, and promotion database 122. In general, a user, such as a first user 106, who has typically had some personal experience with a business, product or service 110 of the merchant 108, engages a respective graphical user interface 112 provided for and displayed on their computing device 114. A computing device may be, for example, a personal computer, or mobile device such as a smart phone or tablet, and may be configured to present the graphical user interface 112 or graphical merchant 124 interface, as appropriate, on a display element of the respective device.

The graphical user interface 112 may be configured to enable the user to perform several steps. For example, the user 106 may upload to the server element 104 user identification data identifying the user, such as the user's name. Further, the user 106 may create or select at least one content item 128 that is visually detectable (for example, a video, moving hologram, or the like) and which preferably includes a personal review or recommendation by the user relevant to a product, service, or business 110 of the merchant 108. The user may then upload the content item 128 to the server element 104. The computing devices 114 and 126 may typically communicate with the server element 104 by way of the Internet. Embodiments of the system 102 and method 100 may store the content item 128 where it is accessible to the merchant 108, for example, in a merchant queue. In preferred embodiments, all uploaded content items 128 are viewable by the uploading user's followers. An associated feature may also be provided by which follower can comment on the content items, and share those items with others.

A graphical merchant interface 124 may be provided for and displayed on a merchant computing device 126. The graphical merchant interface 124 may be configured to enable the merchant to perform several functions. For example, the merchant may upload to the server element 104 merchant identification data identifying the merchant (for example, business name and location). The merchant may view the content item uploaded by the first user 114, and decide whether to reject the content item or commence creation of a promotion incorporating at least part of the content item 128. The merchant may then enter parameters of an offer 130 of a voucher 134, wherein the voucher 134 generally includes a purchase price 178 and is typically a discount or a gift redeemable through the merchant 108.

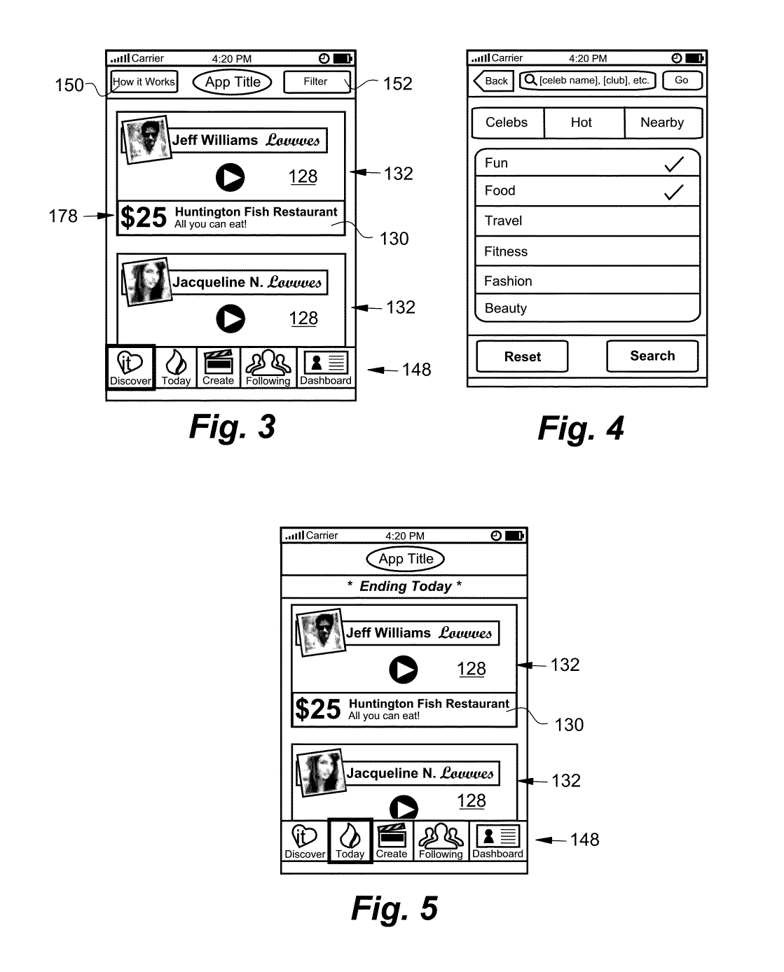

At the direction of the merchant 108, the system 102 and method 100 may generate the promotion 132 by combining, for example, the user identification data, the merchant identification data, the offer 130, and at least part of the content item 128. The promotion 132 may then be published, for example, in association with a graphical purchase interface whereby one or more customers may view the promotion and electively purchase the voucher (see, for example, FIGS. 3, 6-9, 18 and 19). Users (for example, 106 and 136) are also typically considered customers. When viewed by way of, for example, a graphical user interface, the promotion 132 may indicate the number of days remaining until the offer expiration date.

In particular embodiments, the content item 128 may be stored in a merchant queue, and the merchant may be notified, by email for example, when a content item is in their merchant queue. In some embodiments, the graphical merchant interface 124 may be further configured to enable the merchant 108 to trigger the timing of the publishing of the promotion 132.

In certain embodiments, the offer parameters may include at least the purchase price, an offer expiration date, a redemption value and a redemption deadline. In such embodiments, for example, the purchase price is typically less than the redemption value. Further, in such embodiments, before the redemption deadline, the voucher is redeemable through the merchant for the redemption value; whereas after the redemption deadline, the voucher is redeemable through the merchant for at least an amount equal to the purchase price.

In particular preferred embodiments, for each voucher purchased, an operator portion of the purchase price 178 may be retained by the operator and a merchant portion of the purchase price disbursed to the merchant. By way of example, the operator portion may be 25% of the purchase price, and the merchant portion may be 75% of the purchase price. Depending upon the embodiment, an operator may be a person or entity directly operating the server element 104, or controlling, directing, financing or otherwise providing for such operation.

Certain embodiments of a method 100 may further comprise a step of allocating a cash or other redeemable reward to the user for each content item 128 uploaded by the user 106 in which at least part of the respective content item 128 has been incorporated into a promotion 132.

In particular embodiments of a method 100, a user 106 may be cumulatively credited with incentive or status points resulting from at least one or more of: each content item uploaded by the user; each content item uploaded by the user in which at least part of the respective content item has been incorporated into a promotion and at least one purchase of a respective voucher has been made; and each purchase of the respective voucher. In such embodiments, once the incentive points credited to the user reach a point threshold (for example, 300 points), the system and method may allocate to the user a “celeb-status” designation and a redeemable user portion of the purchase price of each respective voucher subsequently purchased. For example, after having reached celeb status, the user may receive cash or discounts equal to 5% of the purchase price of every purchase made beginning at or after the time at which such status has been reached.

In certain embodiments, allocation of celeb status may be designated to the user, either by the user having earning sufficient incentive points or by instant designation provided by the site operator (for example, in the case of well-known personalities/celebrities who may have immediate influence over the buying habits of large numbers of customers). Embodiments may provide a virtual lounge, which may have its own graphical interface, and which may be substantially exclusively accessible by the merchants and celeb-status users. In embodiments, the virtual lounge interface may enable one or more of the following: the merchant to present one or more products or services available for sampling by the celeb-status user; the merchant to send requests to the celeb-status user to sample a product or service of the merchant; the celeb-status user to request a sample of one or more products or services presented by the merchant for sampling by the celeb-status user; and the merchant and celeb-status user to post comments relating to products, services or the business of the merchant.

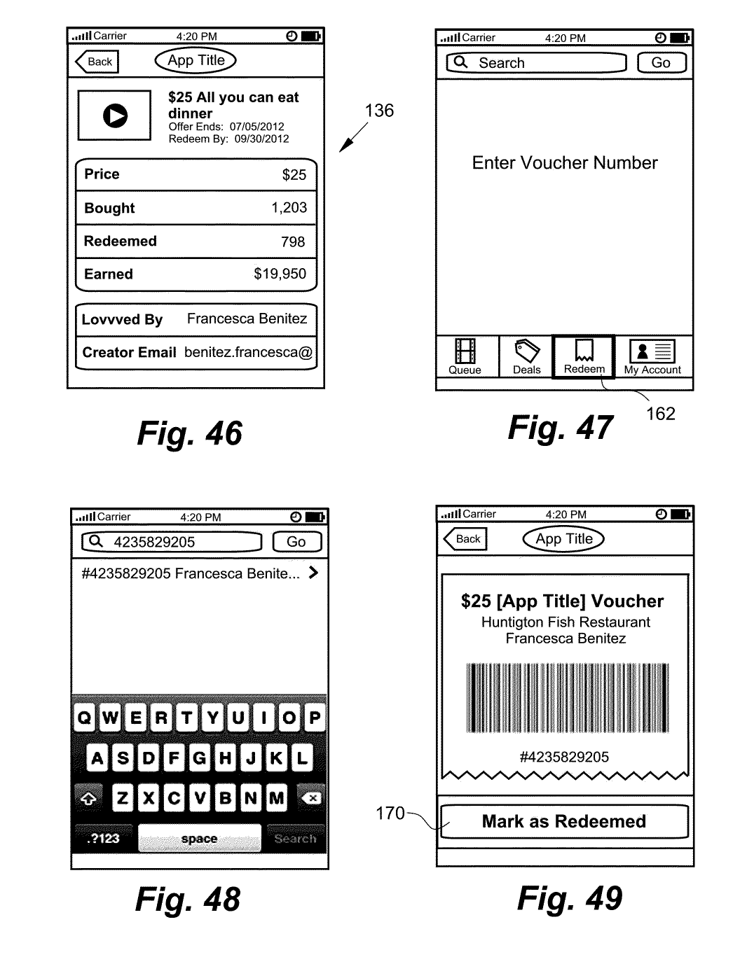

Referring to FIG. 46 for illustration, in particular embodiments, the graphical merchant interface 124 may include an updating deal status indicator 136 which, respective to the published promotion 132, identifies the promotion and displays two or more of the following: the purchase price of the voucher; the number of the vouchers purchased, the number of the vouchers redeemed, and an amount earned by the merchant, wherein the amount earned is an accumulated merchant portion of the purchase price for all of the vouchers purchased by way of the promotion. In certain such embodiments, the updating deal status indicator 136 further identifies the user who created or uploaded the respective content item 128 and an email address of the user.

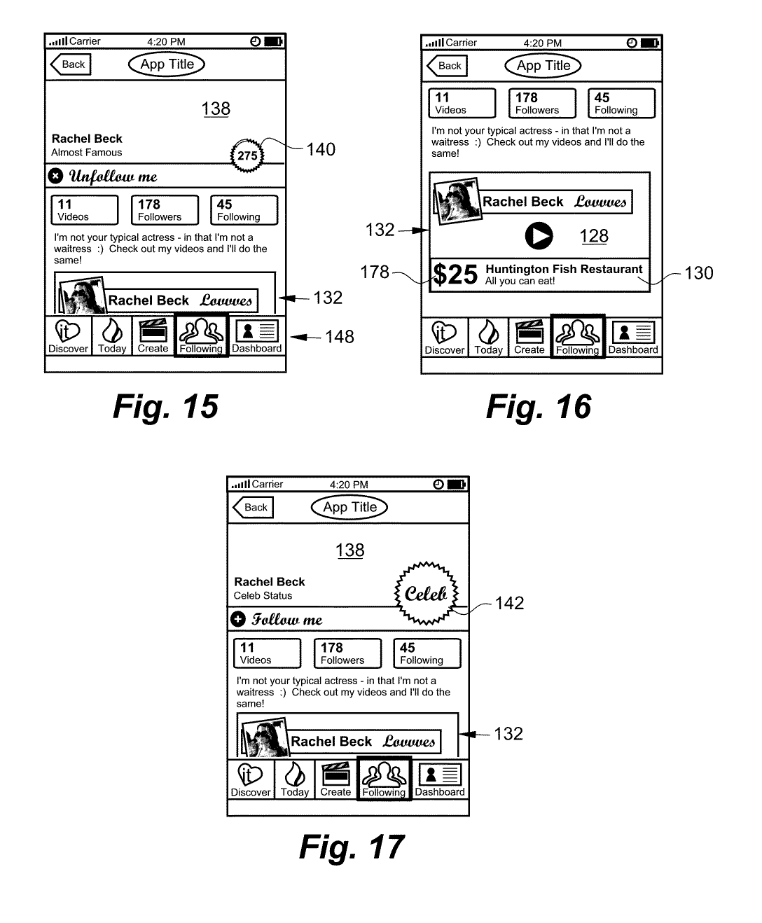

Referring to FIGS. 15-17 for illustration, embodiments may further provide a user profile page viewable to one or more of the customers and displaying one or more of: the user identification data of the user; profile information about the user input by the user; the number of content items uploaded by the user which have been incorporated in published promotions, and the published promotions which incorporate content items uploaded by the user. A profile image 138 may also form part of the profile page. A user profile image may be, for example, a photo of the user. The user profile page may also display the number of points earned 140 by the respective user to date, and if celeb status has been reached, a Celeb Badge 142 or its equivalent.

Referring to FIG. 19 for illustration, in certain embodiments, the graphical purchase interface may be configured to enable a customer who has purchased one of the vouchers to electronically send the purchased voucher to another customer for the other customer to redeem the purchased voucher through the merchant.

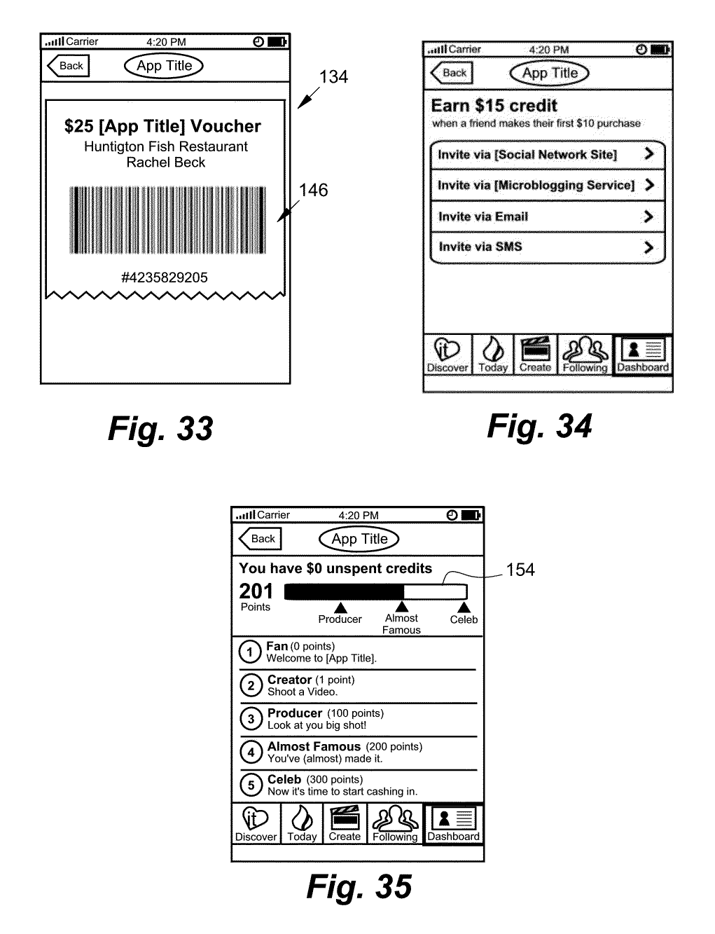

In particular embodiments, the published promotion and graphical purchase interface may be accessible by one or more customers by way of a web browser from any respective computing device. Referring to FIG. 33 for illustration, the graphical user interface 112 may be configured to display a unique redemption code 146 for each voucher purchased or received by the respective customer, wherein the redemption code may be in at least a bar code format. In embodiments, the graphical purchase interface 144 may form part of, or be integral with, the graphical user interface 112.

In certain embodiments, published promotions may be sharable by customers and merchants through one or more of: blog postings, electronic business directories, social media web sites, and emailed web links.

One or more non-transitory computer readable media may have stored thereon software program code operable to cause one or more processors to collectively perform operations comprising steps of various embodiments of the methods discussed herein. For example, the one or more processors may respectively reside in the user and merchant computing devices, and the server element.

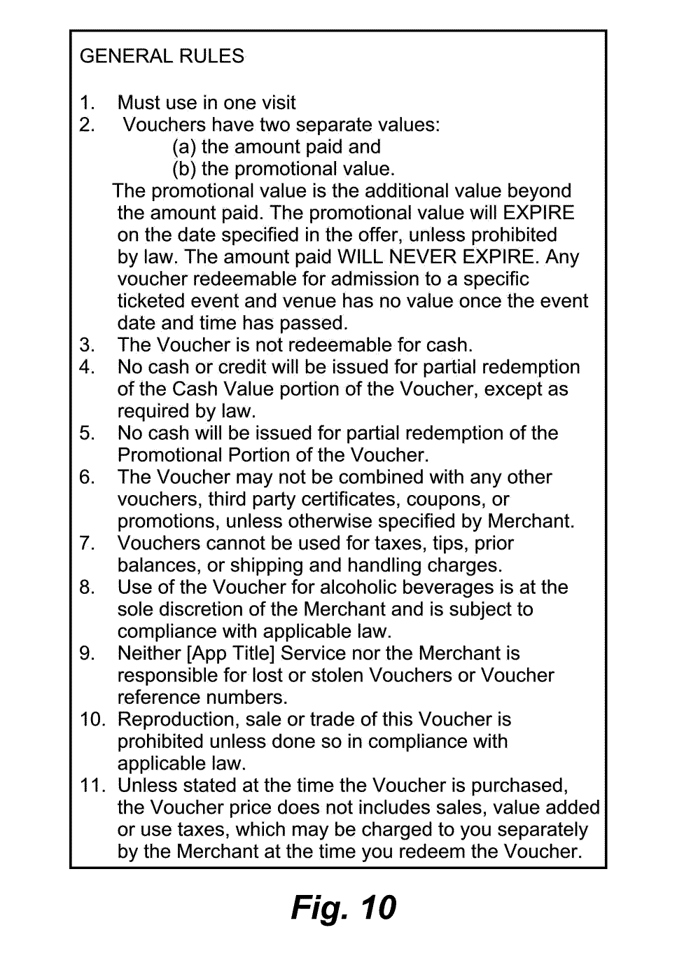

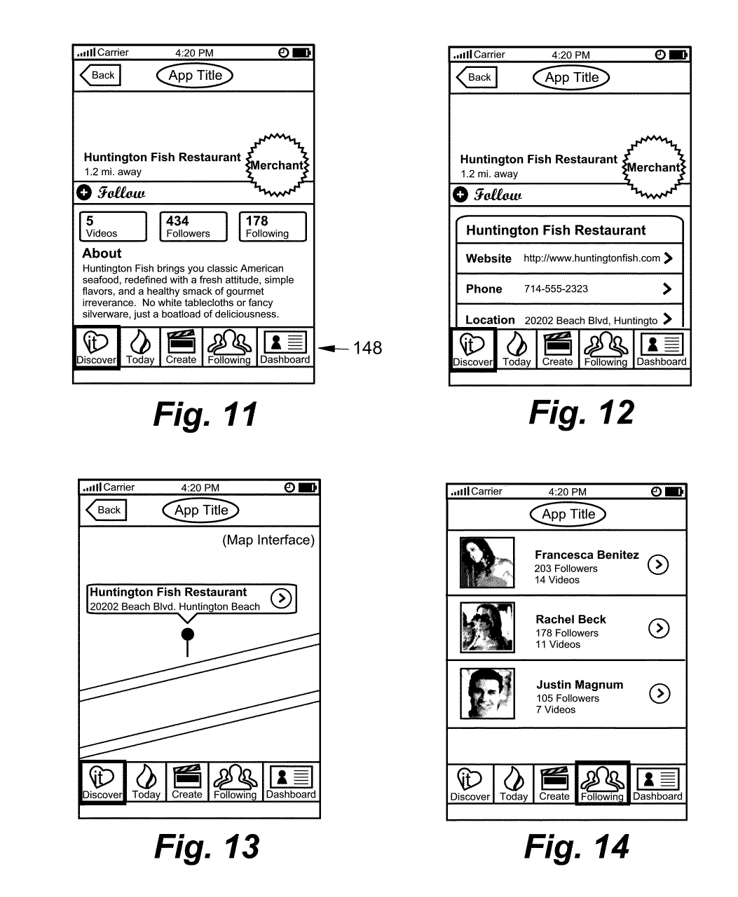

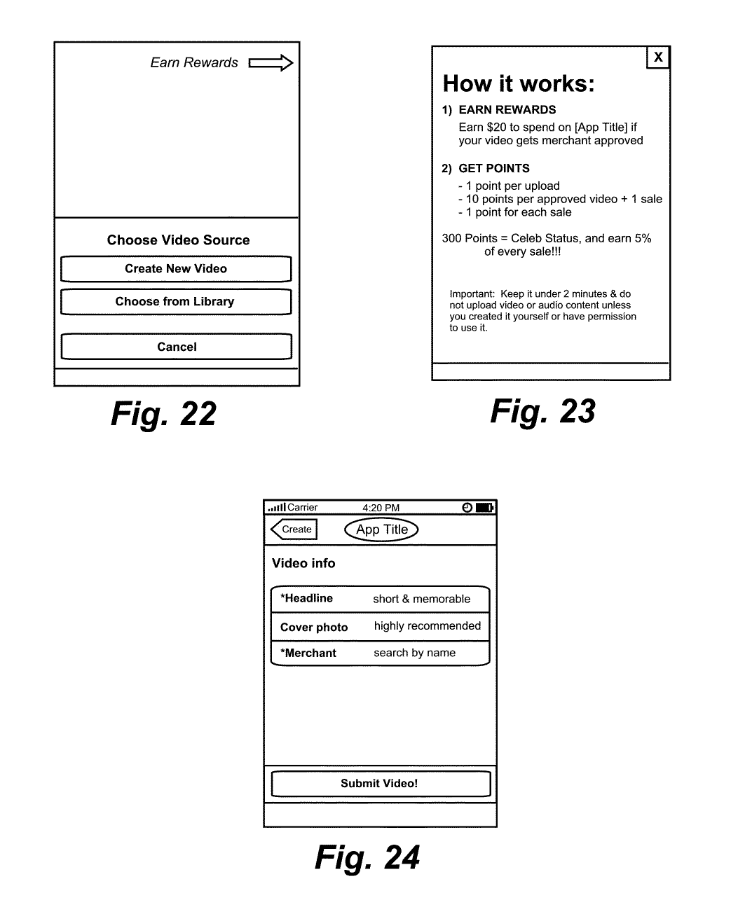

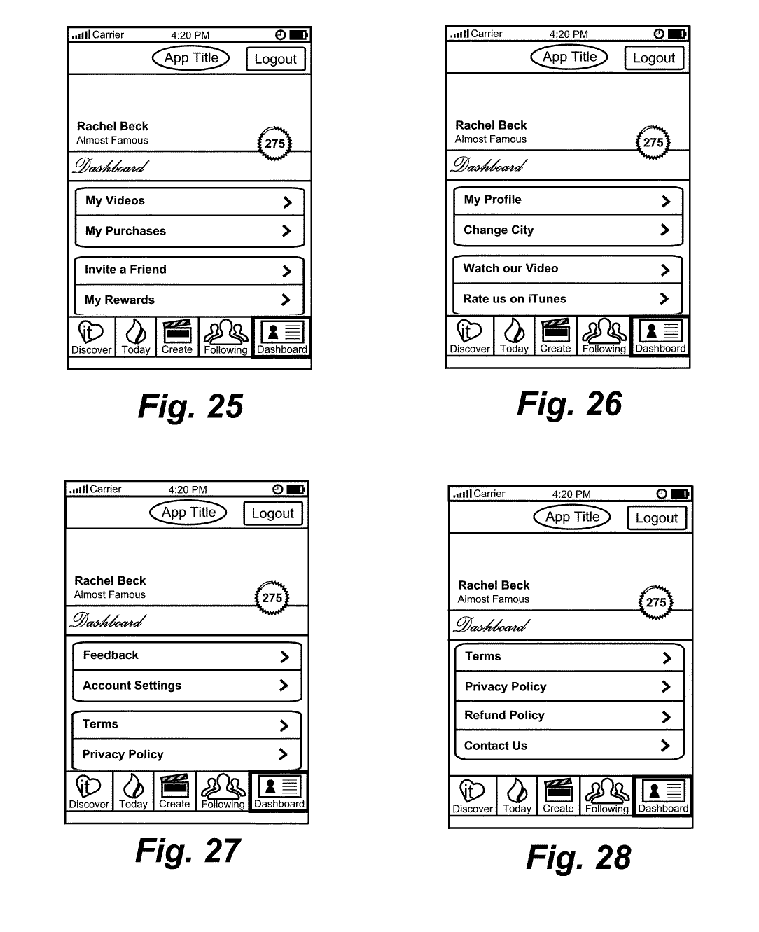

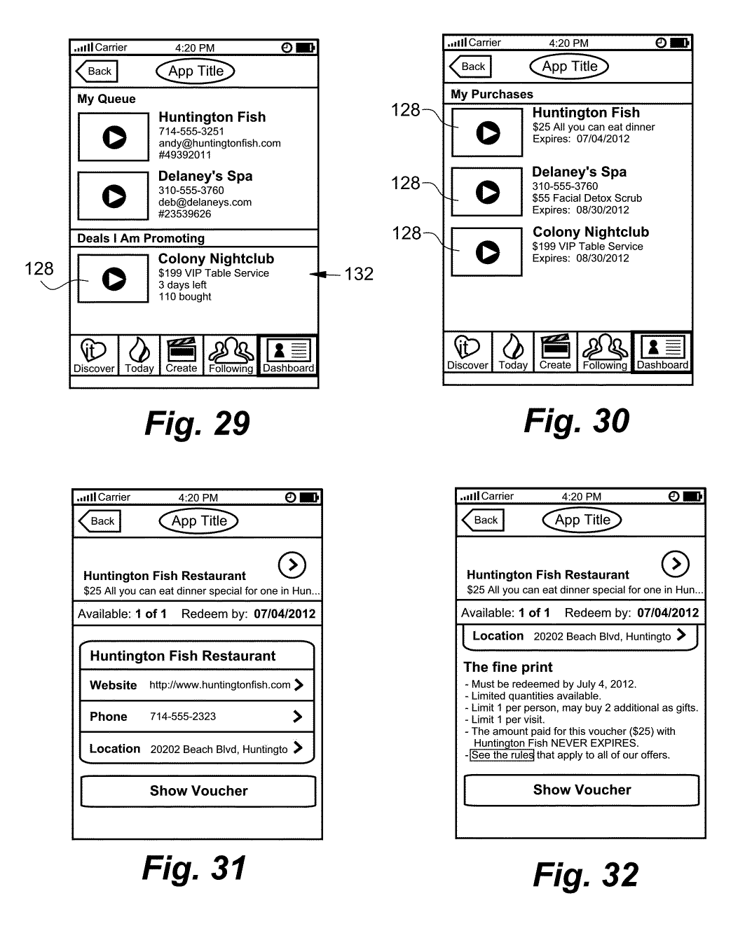

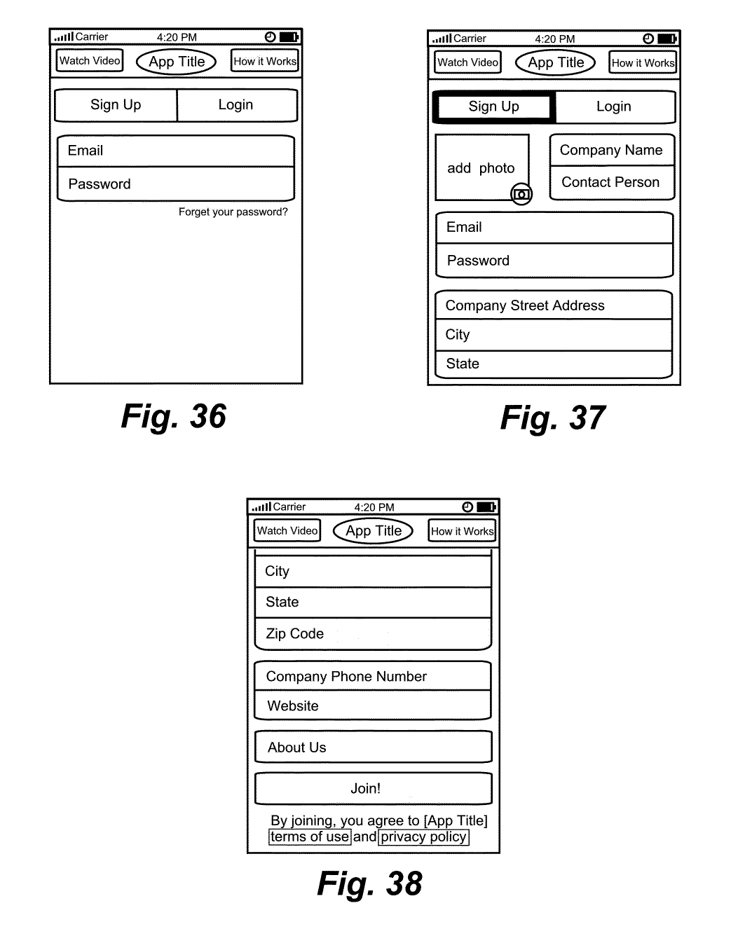

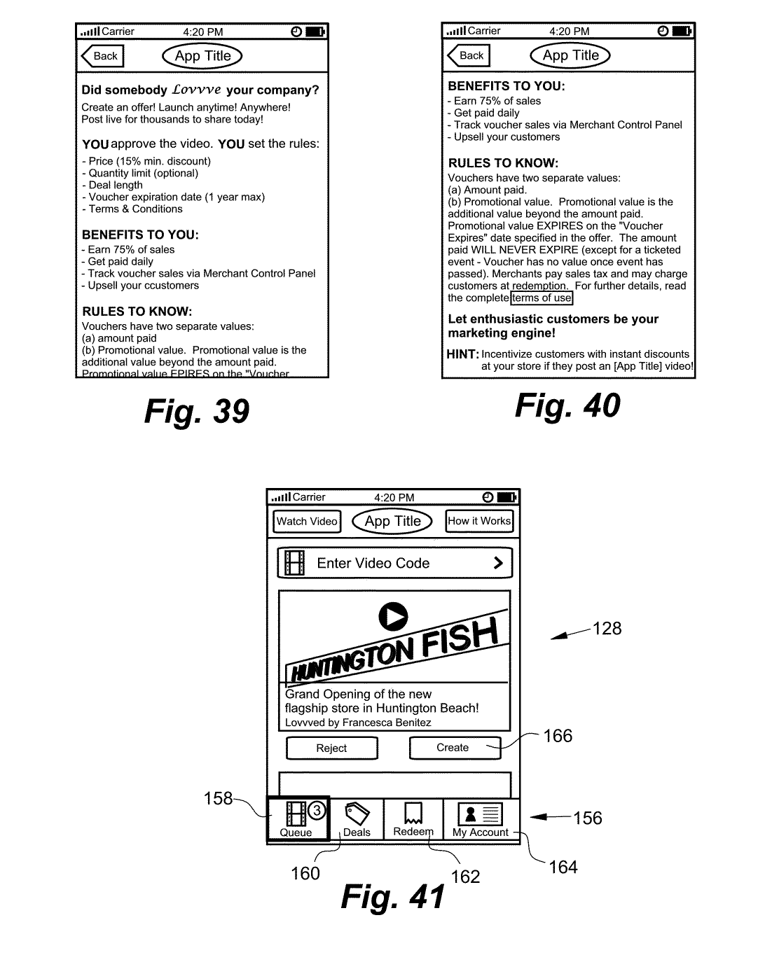

FIGS. 3-36 generally illustrate pages which may form a part of a graphical user interface 112. Similarly, FIGS. 36-52 illustrate pages which may form part of a graphical merchant interface 124. Throughout the figures in this disclosure, icons which are depicted with darkened boarders are generally meant to indicate that the page shown is associated with, or results from, selection of that icon.

Referring to FIG. 3, in operation of particular embodiments, a user may sign in and access their respective graphical user interface 112 and see a user options bar 148. The user options bar 148 may allow the user to navigate to one or more of the following options: discover available promotions, view promotions ending in the current day, create a content item 128 for submission, go to their follow page, and view their dashboard. Selection of the How it Works icon 150 may take the user to text or video describing how the software application and respective processes work. Selection of the Filter icon 152 may take the user to a filter screen as depicted, for example, in FIG. 4. The user may select various categories to narrow which promotions 132 they will be viewing on the discover page.

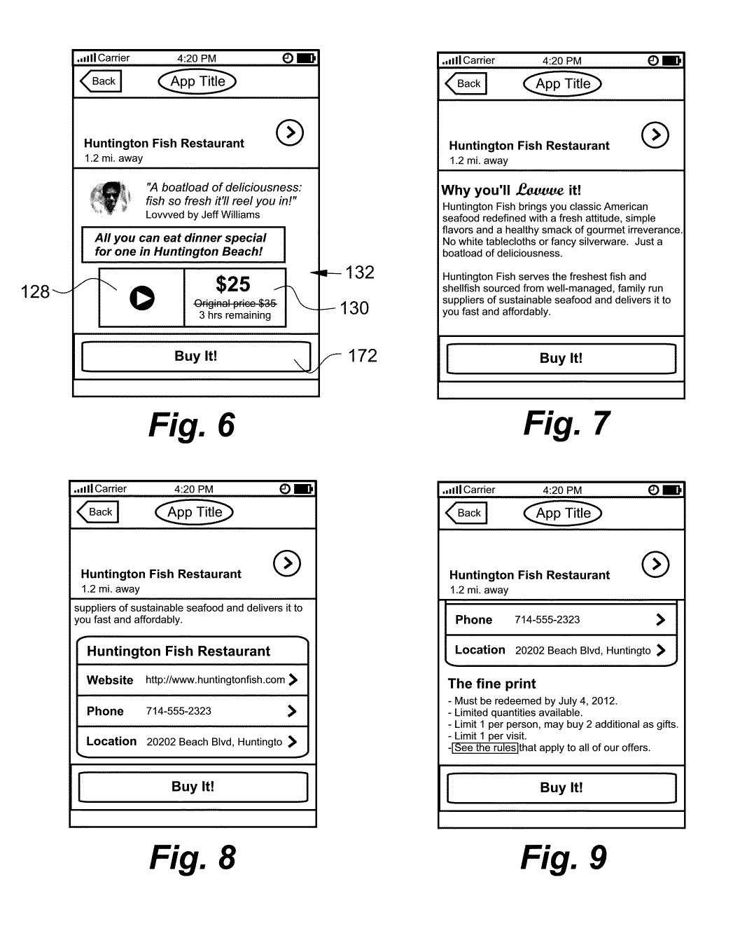

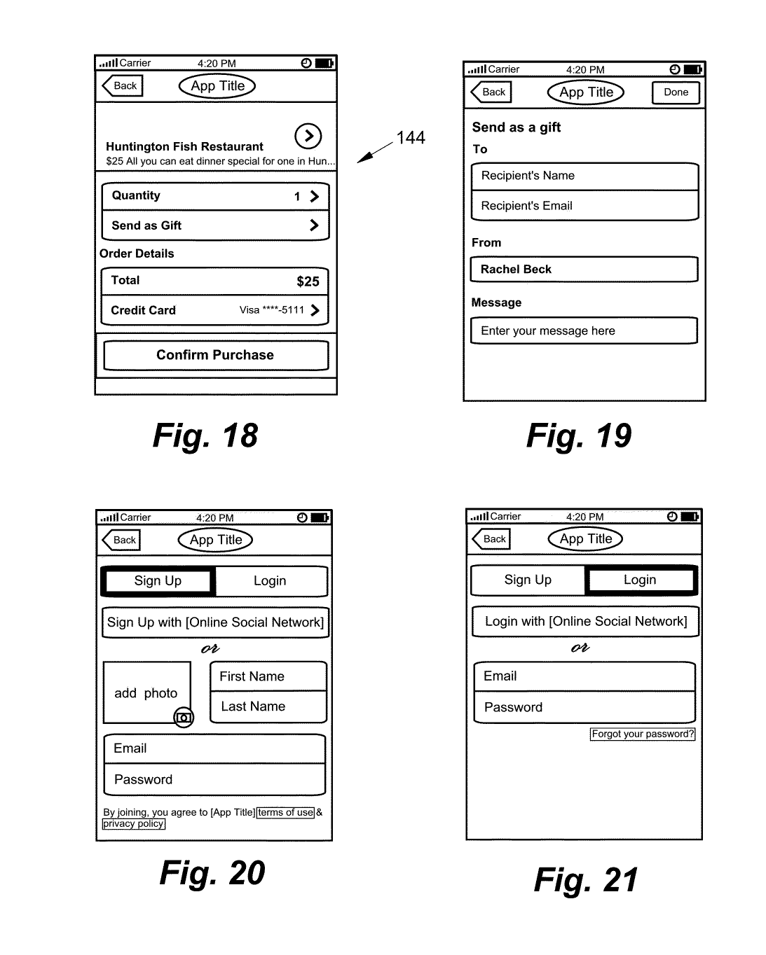

Referring to FIGS. 6-9, having viewed the published promotion 132, a user can review more detailed information about the promotion and the merchant, and choose to purchase the respective voucher by selecting the Buy It icon 172. Selection of the Buy It icon 172 may take the user to the purchase interface page depicted, for example, in FIG. 18. Once the user has entered the required information, they may select the Confirm Purchase icon 174. The user may be able to later access the vouchers they have already purchased by way of, for example, the My Purchases page illustrated in FIG. 30. From this page, if the user wishes to redeem the voucher, they may do so by selecting the specific promotion 132, which may take them to the pages illustrated in FIGS. 31 and 32. By selecting the Show Voucher icon 176, the user may be presented with a voucher image 134 as shown, for example, FIG. 33. The voucher image generally includes a redemption code 146 in alphanumeric format, a variation of a bar code format, a combination thereof, or the equivalent.

FIG. 35 depicts a My Rewards page which may provide a breakdown of the points earned by the user, and the associated user status. A status indicator bar 154, or some variation thereof, may also be provided.

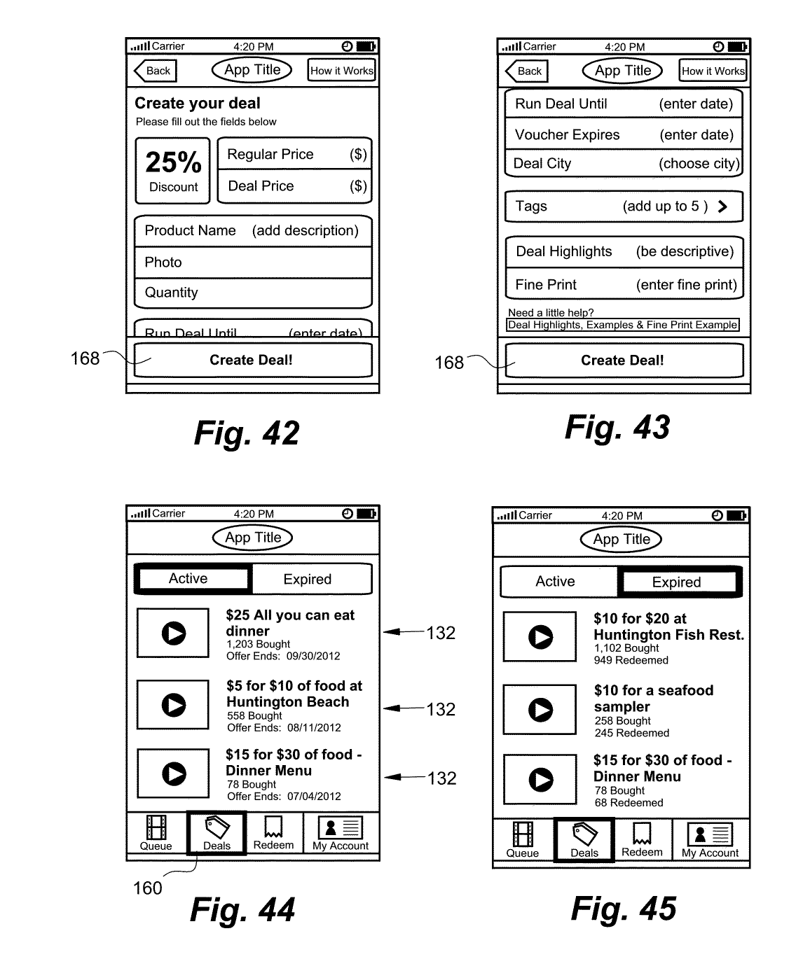

Referring to FIG. 41 for illustration, a merchant may sign in and access their respective graphical merchant interface 124 and see a merchant options bar 156. As illustrated, the Queue icon 158 may take the merchant to a page which pulls up all of the content items 128 which have been submitted by a user and are awaiting review and approval by the merchant. Once the merchant reviews a particular content item 128 in their queue, and they select the Create icon 166, they may be taken to a create deal page as illustrated in FIGS. 42 and 43. The merchant may then enter the parameters of the offer for a voucher, and select the Create Deal icon 168. In certain preferred embodiments, once the Create Deal icon 168 has been selected, the promotion is immediately published.

Referring to FIGS. 44 and 45, the Deals icon 160 may take the merchant to respective pages which pull up all of the merchant's active and expired published promotions, as well as their related statistics. Upon selecting the respective promotion, the merchant may be directed to a page like the one depicted in FIG. 46, which provides more details and statistics relating to the creation and performance of the promotion. In particular embodiments, the merchant may be able to conveniently re-launch a previously expired promotion if the merchant determined the promotion to have been particularly successful.

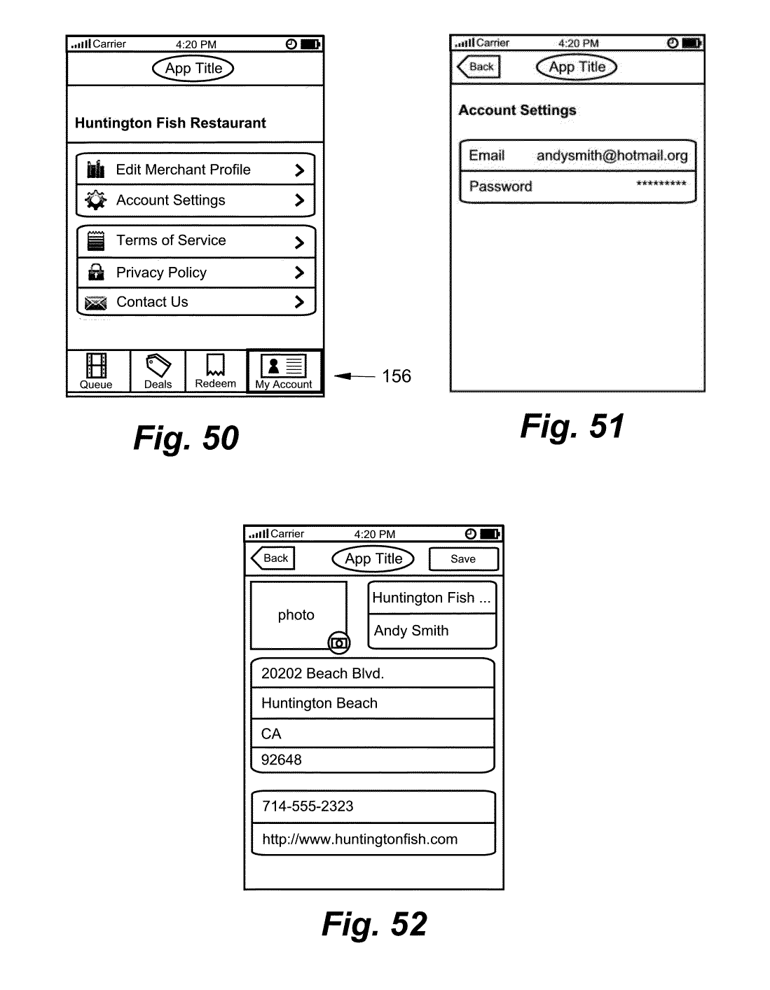

Referring to FIGS. 47-49, selection of the Redeem icon 162 may take the merchant to pages which facilitate the viewing and the redemption of a voucher having been presented by a user. As illustrated in FIG. 49, a Mark as Redeemed icon 170 allows the merchant to instantly account for the redemption of the voucher and prevent its unauthorized re-use. FIGS. 50-52 illustrate My Account pages of the graphical merchant interface which allow the merchant to control and modify the information presented in their merchant profile.

Certain alternative embodiments of the systems and methods described herein may be adapted such that, instead of or in addition to creating an offer for a voucher, a merchant pays the user for ownership or a license in the user's uploaded content item. In further alternative, the system and method may be adapted to provide an outlet by which the merchants can bid on the ownership or license of particular uploaded content items.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of generating electronically published promotions, the method comprising:
providing a server element in communication between at least a user and a merchant;
providing a graphical user interface configured to enable the user to:
upload to the server element user identification data identifying the user,
create or select at least one content item that is visually detectable and which includes a personal review or recommendation by the user relevant to a product, service, or business of the merchant, and
upload to the server element the content item;
storing the content item where it is accessible to the merchant;
providing a graphical merchant interface configured to enable the merchant to:
upload to the server element merchant identification data identifying the merchant,
view the content item,
commence creation of a promotion incorporating at least part of the content item, and
enter parameters of an offer of a voucher, wherein the voucher includes a purchase price and is a discount or a gift redeemable through the merchant;
generating the promotion by combining at least the user identification data, the merchant identification data, the offer, and the at least part of the content item; and
publishing the promotion in association with a graphical purchase interface, whereby the one or more customers may view the promotion and electively purchase the voucher.

2. A method as defined in claim 1 wherein the content item is stored in a merchant queue, the method further comprising:
notifying the merchant when the content item is in the merchant queue; and
wherein the graphical merchant interface is further configured to enable the merchant to trigger the timing of the publishing of the promotion.

3. A method as defined in claim 1 wherein the parameters include at least the purchase price, an offer expiration date, a redemption value and a redemption deadline.

4. A method as defined in claim 3 wherein:
the purchase price is less than the redemption value;
before the redemption deadline, the voucher is redeemable through the merchant for the redemption value; and
after the redemption deadline, the voucher is redeemable through the merchant for at least an amount equal to the purchase price.

5. A method as defined in claim 3 wherein the promotion indicates the number of days remaining until the offer expiration date.

6. A method as defined in claim 1 further comprising:
retaining an operator portion of the purchase price from each purchased voucher; and
disbursing to the merchant a merchant portion of the purchase price from each purchased voucher.

7. A method as defined in claim 1 further comprising:
allocating a cash reward to the user for each said content item uploaded by the user in which at least part of the respective content item has been incorporated into a promotion.

8. A method as defined in claim 1 further comprising:
cumulatively crediting the user with incentive points resulting from at least one or more of:
each said content item uploaded by the user,
each said content item uploaded by the user in which at least part of the respective content item has been incorporated into a promotion and at least one purchase of a respective said voucher has been made, and
each purchase of the respective said voucher; and
once the incentive points credited to the user reach a point threshold, allocating to the user a celeb-status designation and a redeemable user portion of the purchase price of each respective voucher subsequently purchased.

9. A method as defined in claim 1 further comprising:
allocating a celeb status designation to the user; and
providing a virtual lounge graphical interface substantially exclusively accessible by the merchant and the celeb-status user, wherein the virtual lounge interface enables one or more of the following:
the merchant to present one or more products or services available for sampling by the celeb-status user;
the merchant to send requests to the celeb-status user to sample a product or service of the merchant;
the celeb-status user to request a sample of one or more products or services presented by the merchant for sampling by the celeb-status user; and
the merchant and celeb-status user to post comments relating to products, services or business of the merchant.

10. A method as defined in claim 1 wherein the graphical merchant interface includes an updating deal status indicator which, respective to the published promotion, identifies the promotion and displays two or more of:
the purchase price of the voucher,
the number of the vouchers purchased,
the number of the vouchers redeemed, and
an amount earned by the merchant, wherein the amount earned is an accumulated merchant portion of the purchase price for all of the vouchers purchased by way of the promotion.

11. A method as defined in claim 10 wherein the updating deal status indicator further identifies the user and an email address of the user.

12. A method as defined in claim 1 further comprising:
providing a user profile page viewable to one or more of the customers and displaying:
the user identification data of the user;
profile information about the user input by the user,
the number of said content items uploaded by the user which have been incorporated in published promotions, and
the published promotions which incorporate content items uploaded by the user.

13. A method as defined in claim 1 wherein the graphical purchase interface is configured to enable a customer who has purchased one of the vouchers to electronically send the purchased voucher to another customer for the other customer to redeem the purchased voucher through the merchant.

14. A method as defined in claim 1 wherein the published promotion and graphical purchase interface are accessible to one or more customers by way of a web browser.

15. A method as defined in claim 1 wherein the graphical user interface is configured to display a unique redemption code for each voucher purchased or received by the respective customer, wherein the redemption code is in at least a bar code format.

16. A method as defined in claim 1 wherein the graphical purchase interface is part of the graphical user interface.

17. A method as defined in claim 1 wherein the published promotion is sharable by the customers and the merchant through one or more of: blog postings, electronic business directories, social media web sites, and emailed web links.

18. One or more non-transitory computer readable media having stored thereon software program code operable to cause one or more processors to collectively perform operations comprising:
operating a server element in communication between users and merchants;
providing a graphical user interface configured to enable a first said user to:
upload to the server element user identification data identifying the first said user,
create or select at least one video content item which includes a personal review or recommendation by the first said user addressing a product or service of a first said merchant, and
upload to the server element the video content item;
storing the video content item in a first merchant queue;
providing a graphical merchant interface configured to enable the first said merchant to:
upload to the server element merchant identification data identifying the first said merchant,
view the video content item from the first merchant queue,
commence creation of a promotion incorporating at least part of the video content item, and
enter parameters of an offer of a voucher, wherein the voucher has a purchase price and is a discount or gift redeemable through the first said merchant;
generating the promotion by combining at least the user identification data, the merchant identification data, the offer, and the at least part of the video content item; and
publishing the promotion in association with a graphical purchase interface, whereby the one or more customers may view the promotion and electively purchase the voucher.

19. A system comprising:
a first user computing device of a first user;
a second user computing device of a second user;
a first merchant computing device of a first merchant;
a server element in communication between the user computing devices and the first merchant computing device;
wherein the first user computing device is configured to present a graphical user interface to enable the first user to:
upload to the server element user identification data identifying the first user,
create or select at least one video content item which includes a personal review or recommendation by the first user addressing a product or service of the first merchant, and
upload to the server element the video content item;
wherein the server element is configured to store the video content item in a first merchant queue;
wherein the first merchant computing device is configured to present a graphical merchant interface to enable the first merchant to:
upload to the server element merchant identification data identifying the first merchant,
view the video content item from the first merchant queue,
commence creation of a promotion incorporating at least part of the video content item, and
enter parameters of an offer of a voucher, wherein the voucher has a purchase price and is a discount or gift redeemable through the first merchant;
wherein the server element is further configured to generate the promotion by combining at least the user identification data, the merchant identification data, the offer, and the at least part of the video content item; and
wherein the server element is further configured to publish the promotion such that at least the first and second users can view the promotion and electively purchase the voucher by way of their respective computing devices.

20. A system as defined in claim 19 wherein the server element is comprised of a multiplicity of server devices which are not collocated.
